(19) United States
(12) Patent Application Publication
(10) Pub. No.: US 2026/0171478 A1
(43) Pub. Date: Jun. 18, 2026

(54) ELECTRODE COMPOSITIONS COMPRISING SILICON ALLOYS OF ALUMINUM NITRIDE AND BATTERIES CONTAINING THE SAME

(71) Applicant: TRION Energy Solutions Corp., Roseville, MN (US)

(72) Inventor: VINCENT CHEVRIER, Roseville, MN (US)

(21) Appl. No.: 19/535,589

(22) Filed: Feb. 10, 2026

Related U.S. Application Data
(63) Continuation of application No. PCT/US2024/041662, filed on Aug. 9, 2024.
(60) Provisional application No. 63/518,910, filed on Aug. 11, 2023.

(51) Int. Cl. H01M 10/0525; H01M 4/66

(52) U.S. Cl. CPC H01M 10/0525; H01M 4/661

(57) ABSTRACT

This disclosure relates to an electrochemically active material and batteries containing the same. The electrochemically active material comprises an alloy represented by the formula SiₐAl_{b}Ti_{c}N_{d}OₑX_{f} wherein X comprises one or more of carbon, a transition metal, and tin, wherein a+b+c+d+e+f=100, wherein a>25, b>0, c≥0, d>0, d≥b, e≥0, f≥0, wherein a+b+c>d, d+(⅔e) >b, b+c>d, and wherein the alloy includes an inactive phase comprising aluminum.

### CROSS REFERENCE TO RELATED APPLICATIONS

This application is a By-Pass Continuation of PCT/US2024/041662, filed Aug. 9, 2024, which application claims priority under 35 U.S.C. § 119 to provisional patent application U.S. Ser. No. 63/518,910, filed Aug. 11, 2023. These patent applications are herein incorporated by reference in their entirety, including without limitation, the specification, claims, and abstract, as well as any figures, tables, appendices, or drawings thereof.

### TECHNICAL FIELD

This disclosure relates to an electrochemically active material and batteries containing the same. The electrochemically active material comprises an alloy represented by the formula SiₐAl_{b}Ti_{c}N_{d}OₑX_{f} wherein X comprises one or more of carbon, a transition metal, and tin, wherein a+b+c+d+e+f=100, wherein a>25, b>0, c≥0, d>0, d≥b, e≥0, f≥0, wherein a+b+c>d, d+(⅔e) >b, b+c>d, and wherein the alloy includes an inactive phase comprising aluminum.

### BACKGROUND

Various anode compositions have been introduced for use in lithium-ion batteries. Such compositions are described, for example, in Il-seok Kim, P. N. Kumta, and G. E. Blomgren, Electrochem. Solid State Lett., 3 (2000) 493. and Ye Zhang, Zheng-Wen Fu, Qi-Zong Qin, Electrochem. Comm., 6 (2004) 484. Current lithium-ion batteries comprise an anode and a cathode where oxidation and reduction chemistry take place. An electrolyte carries lithium ions between the two electrodes. During battery charge lithium ions migrate from cathode to anode, where lithium ions are reversibly stored. During discharge, the lithium ions are released generating a flow of electrons.

The anode of a lithium-ion battery therefore desirably contains an inactive phase with no initial lithium reactivity, low density to increase the specific capacity of the material, a high bulk modulus, and low cost. Thus, there exists a need in the art for an electrochemically active material with an inactive phase that has a low density, a high bulk modulus, reduced lithium activity, and low cost.

Silicon based materials are a promising alternative to graphite as an anode material for high energy density lithium-ion electrochemical cells due, in part, to their higher energy density. However, it has been difficult to obtain strong electrochemical cell life with known silicon-based anodes because of their high volume expansion during lithiation and propensity to undesirably react with the electrolyte. Silicon-based alloys that include an inactive component have proven successful in providing extended cycle life by lowering volume expansion and reducing electrolyte reactivity. However, further improvement in these areas remains desirable.

### BRIEF SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to provide electrochemically active materials. The electrochemically active materials are particularly suitable for electrochemical cells, batteries, other energy storage devices, and other electronic devices. A benefit of the disclosures is that the electrochemically active materials are rechargeable.

A preferred embodiment comprises an electrochemically active material comprising an alloy represented by the formula: SiₐAl_{b}Ti_{c}N_{d}OₑX_{f} wherein X comprises one or more of carbon, a transition metal, and tin; wherein a+b+c+d+e+f=100; wherein a>25; wherein b>0; wherein c≥0; wherein d>0; wherein d>b; wherein e≥0; wherein f≥0; wherein a+b+c>d; and wherein the alloy comprises an inactive phase comprising aluminum.

The electrochemically active material can be included in an electrode further comprising a binder. Preferably, the electrode is a negative electrode.

Preferred embodiment is an electrochemical cell comprising a negative electrode, a positive electrode, and an electrolyte; where the negative electrode comprises an electrochemically active material comprising an alloy represented by the formula: SiₐAl_{b}Ti_{c}N_{d}OₑX_{f} wherein X comprises one or more of carbon, a transition metal, and tin; wherein a+b+c+d+e+f=100; wherein a>25; wherein b>0; wherein c≥0; wherein d>0; wherein d>b; wherein e≥0; wherein f≥0; wherein a+b+c>d; and wherein the alloy comprises an inactive phase comprising aluminum; and the positive electrode material comprises lithium.

Another preferred embodiment is a method of making an alloy composition represented by the formula: SiₐAl_{b}Ti_{c}N_{d}OₑX_{f} comprising ball milling a powder comprising at least silicon and aluminum in an atmosphere comprising nitrogen, a mixture of nitrogen and oxygen, or air; wherein X comprises one or more of carbon, a transition metal, and tin; wherein a+b+c+d+e+f=100; wherein a>25; wherein b>0; wherein c≥0; wherein d>0; wherein d>b; wherein e≥0; wherein f≥0; and wherein a+b+c>d; and wherein the alloy includes an inactive phase comprising aluminum.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE FIGURES

Various embodiments of the electrochemically active material, batteries comprising the electrochemically active materials, and use of the electrochemically active materials are represented in the figures and tables. The figures and tables do not limit the scope of the invention.

Rather, the figures and tables provided herein are not limitations to the various embodiments according to the invention and are presented as non-limiting examples of the disclosure.

FIG. 1 is a table providing seventeen example electrochemically active compositions and five comparative examples (CE); the table includes the synthesis methods, atomic compositions, Scherrer grain size of the Silicon phase, and Scherrer grain size of the largest peak.

FIG. 2 is a table providing the reversible capacity (mAh/g), first cycle efficiency (FCE), and pycnometer density (g/ml) for the seventeen example electrochemically active compositions and five comparative examples (CE).

FIG. 3 is a table providing the atomic percentages and the application of stoichiometric rules for the design of aluminum containing nanostructured silicon alloys for the seventeen example electrochemically active compositions and five comparative examples (CE).

FIG. 4 shows an X-ray diffraction (XRD) spectra of electrochemically active materials prepared in Example 1. The Si and AlN phases are identifiable by XRD and are identified as primarily Si and hexagonal AlN.

FIG. 5 shows the electrochemical performance of electrochemically active materials prepared in Example 1.

FIG. 6 shows an XRD spectra of electrochemically active materials prepared in Example 2 using a roller mill and comprising silicon, aluminum, and titanium powders under nitrogen atmosphere.

FIG. 7 shows an XRD spectra of electrochemically active materials prepared in Example 3 using a roller mill and comprising silicon, aluminum, and titanium powders under nitrogen atmosphere. The Si and TiSi₂ phases are visible; the aluminum nitride phase is fully amorphous.

FIG. 8 shows an XRD spectra of electrochemically active materials prepared in Example 9 showing the presence of iron silicide, titanium silicide, cubic aluminum nitride, and silicon phases.

FIG. 9 shows an XRD spectra of electrochemically active materials prepared in Example 17 using a roller mill and comprising silicon, alumina, and hexagonal aluminum nitride powders. The spectra shows the presence of silicon, hexagonal aluminum nitride, and alumina phases.

FIG. 10 shows an XRD spectra of electrochemically active materials prepared with a roller mill using silicon and aluminum powders to form a SiAl alloy. The spectra shows silicon and aluminum phases are present in the resulting alloy.

FIG. 11 shows an XRD spectra of electrochemically active materials prepared with a roller mill using silicon and alumina (Al₂O₃) powders to form a SiAlO alloy. The spectra shows silicon and alumina phases are present in the resulting alloy.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described

### Definitions

So that the present invention may be more readily understood, certain terms are first defined. Unless defined otherwise, all technical and scientific terms used herein have the same meaning as commonly understood by one of ordinary skill in the art to which embodiments of the invention pertain. While many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

All terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

References to elements herein are intended to encompass any or all of their oxidative states and isotopes. For example, discussion of silicon can include Si⁻⁴, Si⁻³, Si⁻², Si⁻¹, Si¹, Si², Si³, or Si⁴ and any of its isotopes, e.g., ²⁸Si, ²⁹Si, and ³⁰Si.

The term “about,” as used herein, refers to variations in size, distance or any other types of measurements that can be resulted from inherent heterogeneous nature of the measured objects and imprecise nature of the measurements itself, including, but not limited to, size, mass, volume, time, distance, density, wavelength, frequency, voltage, current, absorption, gain, capacity, a ratio, photoresponsivity, and electromagnetic field. The term “about” also encompasses variation in the numerical quantity that can occur, for example, through typical measuring or handling procedures in the real world; through inadvertent error in these procedures; through differences in the manufacture, source, or purity of the ingredients used to make the device or carry out the methods, and the like. Whether or not modified by the term “about”, the claims include equivalents to the quantities.

As used herein, “alloy” refers to a substance that includes a mixture of any or all of metals, metalloids, semimetals, or semiconductors.

As used herein, “charge” and “charging” refer to a process for providing electrochemical energy to a cell, while “discharge” and “discharging” refer to a process for removing electrochemical energy from a cell, e.g., when using the cell to perform desired work. As used herein, the phrase “charge/discharge cycle” refers to a cycle wherein an electrochemical cell is fully charged, i.e. the cell attains its upper cutoff voltage and the cathode is at about 100% state of charge, and is subsequently discharged to attain a lower cutoff voltage and the cathode is at about 100% depth of discharge.

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

It is to be appreciated that certain features that are, for clarity, described herein in the context of separate embodiments, may also be provided in combination in a single embodiment.

Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

As used herein, an “electrochemically active material” refers to a material that is electrochemically active and which comprises at least one electrochemically active phase and may also comprise at least one electrochemically inactive phase.

As used herein, “electrochemically active” refers to a material, or portion of a material, or a phase capable of a chemical reaction involving charge transfer, or electron exchange, for example through reduction-oxidation. As an example, an electrochemically active phase may reversibly alloy with lithium when incorporated into a negative electrode in a lithium-ion battery. The phrases “electrochemically active phase” or “active phase” refer to a phase of an electrochemically active material that can electrochemically react or alloy with lithium under conditions possibly encountered during charging and discharging at the negative electrode in a lithium ion battery (e.g., voltages between 0 V and 2 V versus lithium metal).

As used herein, “electrochemically inactive” refers to a material, or portion of material, or a phase that is not electrochemically reactive. As an example, an electrochemically inactive phase does not reversibly alloy with lithium when incorporated into an anode in a lithium-ion battery. The phrases “electrochemically inactive phase” or “inactive phase” refer to phases of an electrochemically active material that does not electrochemically react or alloy with lithium under conditions possibly encountered during charging and discharging at the negative electrode in a lithium ion battery (e.g., voltages between 0 V and 2 V versus lithium metal).

As used herein, “half-cell” refers to a two electrode electrochemical cell where one electrode is the working electrode and the other electrode is a lithium metal counter/reference electrode. As used herein, “positive electrode” or “cathode” refers to an electrode where electrochemical reduction and lithiation occurs during a discharging process in a full cell, and “negative electrode” or “anode” refers to an electrode where electrochemical oxidation and delithiation occurs during a discharging process in a full cell. As used herein, “full cell” refers to a two electrode electrochemical cell where neither of the electrodes are lithium metal (e.g., a lithium ion battery).

As used herein, “lithiate” and “lithiation” refer to a process for adding lithium to an electrode material or electrochemically active phase and “delithiate” and “delithiation” refer to a process for removing lithium from an electrode material or electrochemically active phase.

As used herein “phase” refers to a region of a material having uniform composition and atomic structure, “amorphous phase” refers to a phase whose average grain size is less than 2 nm as determined by application of the Scherrer equation to the full width at half maximum (FWHM) of any one of its diffraction peaks between 20° and 60° 2-theta under incident Cu-Kα radiation.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, sub-combinations, or the like that would be obvious to those skilled in the art

As used herein, “substantially homogeneous” refers to a material in which the components or domains of the material are sufficiently mixed with one another such that the physical properties of one portion of the material is the same as that of any other portion of the material on a length scale of 100 nanometers or more.

As used herein, “Scherrer grain size” of a phase of refers to the average grain size of the phase as determined by application of the Scherrer equation to the FWHM of any one of its diffraction peaks between 200 and 600 2-theta under incident Cu-Ka radiation.

### Alloy Compositions and Their Uses

Disclosed herein is an alloy represented by the formula SiₐAl_{b}Ti_{c}N_{d}OₑX_{f} wherein X comprises one or more of carbon, a transition metal, and tin, wherein a+b+c+d+e+f=100, wherein a>25, b>0, c≥0, d>0, d≥b, e≥0, f≥0, wherein a+b+c>d, and wherein the alloy comprises an inactive phase comprising aluminum. In an embodiment, d+⅔e>b, and b+c>d. Most preferably, a is greater than about 25 and less than about 85; b is greater than 0 and less or equal to about 50; c is equal to or greater than 0 and equal to or less than about 20; d is greater than 0 and equal to or less than about 50; e is equal to or greater than 0 and equal to or less than about 50; and f is equal to or greater than 0 and equal to or less than about 30. Thus, in one or more embodiments any of c, e and f may be absent from the alloy composition.

Without being limited to a specific theory or mechanism, Applicants have found that aluminum nitride is stable in the presence of lithium metal. Nitrogen was found to form a truly inactive binary phase with aluminum. Furthermore, nitrogen is relatively inexpensive and the aluminum nitride phase has a low density relative to other metal-based inactive phases.

In an embodiment, the alloy described herein comprises an inactive phase. In an embodiment, the inactive phase comprises aluminum nitride. In an embodiment, the inactive phase comprises a Scherrer grain size less than about 25 nm, or less than about 22 nm, or less than about 20 nm, or less than about 15 nm, or less than about 10 nm.

In an embodiment the alloy comprises a transition metal silicide phase. In an embodiment, the alloy comprises a transition metal silicide phase, wherein the phase has a Scherrer grain size between about 1 nm and about 25 nm, or between about 1 nm and about 22 nm.

In an embodiment, X comprises one or more of V, Cr, Mn, Fe, Co, Ni and Cu. In an embodiment, X comprises carbon. In an embodiment, X comprises one or more of carbon, V, Cr, Mn, Fe, Co, Ni and Cu. In an embodiment, X comprise carbon and Fe.

In an embodiment, the alloy comprises titanium silicide. In an embodiment, the alloy comprises a phase having x-ray diffraction peaks characteristic of a titanium silicide phase and is free of peaks characteristic of a titanium nitride phase. In an embodiment, the alloy is free of titanium nitride.

In an embodiment, the alloy comprises an elemental silicon phase. In an embodiment, the elemental silicon phase comprises a Scherrer grain size that is less than or equal to about 20 nm, or less than or equal to about 17 nm, or less than 15 nm, or less than 10 nm, or less than 5 nm.

In an embodiment, the inactive phase comprises one or more grains. In an embodiment, the inactive phase comprises one or more grains wherein the x-ray diffraction pattern of the alloy comprises no detectible Cu-Ka diffraction peaks whose FWHM correspond to a grain size greater than about 25 nm, greater than about 22 nm, greater than 20 nm, greater than 15 nm, greater than 10 nm, or greater than 5 nm according to the Scherrer equation.

In an embodiment, the alloy has a value of r₁₀ that is less than or equal to about 0.40, or less than or equal to about 0.35, or less than 0.25, or less than 0.20.

In an embodiment, the alloy has a reversible capacity greater than about 900 mAh/g and less than about 2500 mAh/g.

In an embodiment, the alloy has a density of less than about 3.6 g/ml. Preferably the alloy has a density of between about 2.2 g/ml and about 3.6 g/ml; more preferably between about 2.4 g/ml and 3.5 g/ml; still more preferably between 2.8 g/ml and 3.4 g/ml; most preferably between 3 g/ml and 3.3 g/ml.

In an embodiment, the alloy comprises a first cycle efficiency greater than about 75%, or greater than about 77%, or greater than 80%, or greater than 85%, or greater than 90%.

Disclosed herein is an electrochemically active material comprising the alloy as described herein. Disclosed herein is an electrode composition comprising the electrochemically active comprising the alloy as described herein. Disclosed herein is an electrode composition comprising the alloy as described herein.

Disclosed herein is an electrode comprising the alloy as described herein. Disclosed herein is an electrode composition comprising an electrochemically active material comprising the alloy as described herein. In an embodiment, the electrode composition comprises the alloy as described herein and a binder. In an embodiment, the electrode composition comprises an electrochemically active material comprising the alloy as described herein and a binder. In an embodiment, the binder comprises a polyelectrolyte. In an embodiment, the binder comprises a polymer electrolyte. In an embodiment, the binder comprises a polymer electrolyte comprising an organic polymer and a lithium salt. In an embodiment, the organic polymer comprises polyethers, polycarbonates, polyacrylates, polynitriles, and polyalkylenes. In an embodiment, the polymer comprises polyacrylate. In an embodiment, the binder comprises lithium polyacrylate. In an embodiment, the binder is lithium polyacrylate. If a binder is included, it is preferably in a ratio to the alloy of about 1:4 through about 1:20, more preferably of about 1:5 through about 1:15, and most preferably of about 1:6 through about 1:10.

In an embodiment, the electrode composition further comprises carbon-based micro- and nano-materials, including, but not limited to, graphite, graphene, carbon black, carbon nanotubes, small flake graphite, and combinations thereof. Most preferably, in an embodiment, the electrode composition further comprises graphite and an additional carbon-based material.

Disclosed herein is a negative electrode comprising the alloy and/or the electrochemically active material comprising the alloy as described herein. Disclosed herein is a negative electrode comprising the electrode composition as described herein. In an embodiment, the negative electrode further comprises a current collector. As described herein, a current collector is used to provide electrical conduction between an electrode and an external part, such as a circuit. Additionally, a current collector may act as a support for the coating of the electrode materials. Examples of a current collector include, but are not limited to Al, Cu, Ni, Ti, carbonaceous material, and stainless steel. Currently collectors can be of any form as known in the art, including but not limited to, a foil, a mesh, a coating, and/or a foam.

Disclosed herein is an electrochemical cell comprising a negative electrode as described herein, a positive electrode comprising lithium, an electrolyte comprising lithium, and a separator.

The positive electrode can be any positive electrode comprising lithium that is known in the art. Exemplary positive electrodes include, but are not limited to, lithium oxides such lithiated transition metal oxides or sulfides.

The electrolyte can be any electrolyte as known in the art. Different classes of electrolytes may be used including non-aqueous electrolytes, aqueous solutions, ionic liquids, polymer electrolytes (solid state and gel state), and hybrid electrolytes. In an embodiment, the electrolyte can further comprise conductive aids. Exemplary electrolytes include, but are not limited to, a lithium salt such as LiPF₆, LiClO₄, LiBF₆, and LiASF₆ in an organic solvent. In an embodiment, the electrolyte is a liquid, a gel polymer, or a solid. In an embodiment, the electrolyte additionally comprises a film-forming additive, a conductive additive, flame retardant additive, overcharge protection additive, and the like.

In a preferred embodiment, the electrolyte comprises one or more electrolyte additives. Preferred electrolyte additives include, but are not limited to, vinylene carbonate (VC), fluoroethylene carbonate (FEC), ethylene sulfite (ES), methylene ethylene carbonate (MEC), vinyl ethylene carbonate (VEC), maleimide (MI), 2,2-Dimethoxy-propane (DMP), vinyl acetate (VA), divinyl adipate (DVA), propylene sulfite (PyS), 1,3-propane sultone (PS), butyl sultone (BS), vinyl ethylene sulfite (VES), prop-1-ene-1,3-sultone (PES), methylene methanedisulfonate (MMDS), glutaric anhydride (GA), N-(triphenylphosphoranylidene)-aniline (TPPA), 1,3,2-dioxathiolane-2,2-dioxide (DTD), phenyl boronic acid ethylene glycol ester (PBE), 2,4,6-trivinylcyclotriboroxane (tVCBO), Ethyl 3,3,3-trifluoropropanoate (TFPE), p-Toluenesulfonyl isocyanate (PSTI), triethylborate (TEB), tris(trimethylsilyl)borate (TMSB), tris(trimethylsilyl)phosphite (TMSPi), tris(2,2,2-trifluoroethyl)phosphite (TTFPi), tris(trimethlysilyl)phosphite (TTSPi), triethyl phosphite (TEPi),triphenyl phosphite (TPPi), phenyl vinyl sulfone (PVS), dimethylacetamide (DMAc), 1,1′-Sulfonyldiimidazole (SDM), p-Toluenesulfonyl isocyanate (PTSI), 1,3-Propane sultone (PSu), 1,3-propanediolcyclic sulfate (PCS), ethyl 3,3,3-trifluoropropanoate (TFPE), terthiophene (3THP), ammonium perfluorocaprylate (APC), lithium bis(oxalate)borate (LiBOB), lithium difluoro(oxalato)-borate (LiDFOB), lithium tetrafluoro(oxalato) phosphate (LTFOP), lithium tris(oxalato) phosphate (LTOP), metal nitrates (e.g., LiNO₃, KNO₃, CsNO₃, LaNO₃), dimethyl methylphosphonate (DMMP), diethyl ethylphosphonate (DEEP), triphenyl phosphate (TPP), tri-(4-methoxythphenyl) phosphate (TMPP), cresyl diphenyl phosphate (CDP), diphenyloctyl phosphate (DPOF).

Disclosed herein is an electronic device comprising the electrochemical cell as described herein. As used herein, an electronic device is any device that contains components to control the flow of electrical currents for the purpose of information control, system control and/or powering any part of said device. Electrochemical cells described herein can be used to power a variety of devices and are not limited to any particular devices or energy storage systems.

Preferred devices include, but are not limited to wearable devices, portable electronic devices, laptop computers, tablet computers, smartphones, hybrid and/or electric cars, grid storage units, residential energy storage units, and/or other electronic devices, for example. An electrochemical cell can be directly connected as a power source and/or included as part of a battery assembly, for example. In some embodiments, the electrochemical cell and/or alloy can be added to a substrate (including, but not limited to, a glass substrate, a metal substrate, a silicon wafer, amorphous silicon, a plastic, a composite, or a combination thereof).

In a preferred embodiment, an electrochemical cell having a negative electrode comprising the alloy has a volumetric capacity of at least about 500 Wh/l. The maximum capacity can vary based on the other components, but is typically not higher than about 1500 Wh/l. Most preferably, the volumetric capacity is from about 500 Wh/l to about 1400 Wh/l, from about 500 Wh/l to about 1300 Wh/l, from about 500 Wh/l to about 1200 Wh/l, from about 500 Wh/l to about 1100 Wh/l, from about 500 Wh/l to about 1000 Wh/l, from about 500 Wh/l to about 950 Wh/l, from about 500 Wh/l to about 900 Wh/l, from about 500 Wh/l to about 850 Wh/l, from about 500 Wh/l to about 800 Wh/l, from about 750 Wh/l to about 700 Wh/l.

### Methods of Preparing the Alloys

Disclosed herein are methods for making the alloy compositions described herein. In an embodiment, the method comprises ball milling a powder comprising at least silicon and aluminum in an atmosphere comprising nitrogen, a mixture of nitrogen and oxygen, or air. In an embodiment, the method comprises ball milling silicon, aluminum, and titanium in an atmosphere comprising nitrogen, a mixture of nitrogen and oxygen, or air. In an embodiment, the method comprises ball milling silicon, aluminum, and one or more of carbon, a transition metal and tin in an atmosphere comprising nitrogen, a mixture of nitrogen and oxygen, or air. In an embodiment, the method comprises ball milling silicon, aluminum, titanium, and one or more of carbon, a transition metal and tin in an atmosphere comprising nitrogen, a mixture of nitrogen and oxygen, or air. As used herein “ball milling” refers to a method of grinding, mixing, or blending materials by way of impact and size reduction as balls collide with each other. In an embodiment, ball mills rotate around a horizontal axis partially filled with the materials to be combined. Various materials can be used as the grinding medium including, but not limited to, ceramic balls, flint pebbles, steel balls, and stainless-steel balls. In an embodiment, the method comprises planetary ball milling. As used herein, “planetary ball milling” refers to a ball mill that is smaller than common ball mills and used to grind materials to very small sizes. U.S. Pat. No. 8,287,772 describes suitable milling techniques in greater detail, of which the detailed disclosure and figures are incorporated herein by reference in their entirety.

Disclosed herein is a method of making an electrochemical cell. In an embodiment, the method of making an electrochemical cell comprises providing a positive electrode comprising lithium, providing a negative electrode according to the disclosure described herein, providing an electrolyte comprising lithium, and incorporating the positive electrode, the negative electrode, and the electrolyte into an electrochemical cell.

### EXAMPLE EMBODIMENTS

The inventions are defined in the claims. However, below is a non-exhaustive list of non-limiting embodiments in numbered format. Any one or more of the features of these embodiments may be combined with any one or more features of another example, embodiment, or aspect described herein. Accordingly, the following numbered clauses form part of the present disclosure but do not form part of the claims:
1. An electrochemically active material comprising an alloy represented by the formula: SiₐAl_{b}Ti_{c}N_{d}OₑX_{f}
   wherein X comprises one or more of carbon, a transition metal, and tin; wherein a+b+c+d+e+f=100; wherein a>25; wherein b>0; wherein c≥0; wherein d>0; wherein d>b; wherein e≥0; wherein f≥0; wherein a+b+c>d; and wherein the alloy comprises an inactive phase comprising aluminum.
2. The electrochemically active material of clause 1, wherein the inactive phase comprises aluminum nitride.
3. The electrochemically active material of any one of clauses 1-2, wherein d+(⅔e)>b.
4. The electrochemically active material of any one of clauses 1-3, wherein b+c>d.
5. The electrochemically active material of any one of clauses 1-4, wherein a is greater than about 25 and less than about 85, b is greater than 0 and less or equal to about 50, c is equal to or greater than 0 and equal to or less than about 20, d is greater than 0 and equal to or less than about 50, e is equal to or greater than 0 and equal to or less than about 50, and f is equal to or greater than 0 and equal to or less than about 30.
6. The electrochemically active material of any one of clauses 1-5, wherein the inactive phase comprises a Scherrer grain size less than about 25 nm, or less than about 22 nm.
7. The electrochemically active material of any one of clauses 1-6, wherein the alloy comprises a transition metal silicide phase, wherein the phase has a Scherrer grain size between about 1 nm and about 25 nm, or between about 1 nm and about 22 nm.
8. The electrochemically active material of any one of clauses 1-7, wherein X comprises C, V, Cr, Mn, Fe, Co, Ni or Cu.
9. The electrochemically active material of any one of clauses 1-8, wherein X comprises carbon.
10. The electrochemically active material of any one of clauses 1-9, wherein X comprises C and Fe.
11. The electrochemically active material of any one of clauses 1-10, wherein the alloy comprises a transition metal silicide phase.
12. The electrochemically active material of any one of clauses 1-11, wherein the alloy comprises a phase having x-ray diffraction peaks characteristic of a titanium silicide phase and is free of peaks characteristic of a titanium nitride phase.
13. The electrochemically active material of any one of clauses 1-12, wherein the alloy comprises an elemental silicon phase having a Scherrer grain size that is less than or equal to about 20 nm, or less than or equal to about 17 nm.
14. The electrochemically active material of any one of clauses 1-13, wherein the inactive phase comprises one or more grains, and wherein the x-ray diffraction pattern of the alloy comprises no detectible Cu-Kα diffraction peaks whose FWHM correspond to a grain size greater than about 25 nm, or greater than about 22 nm, according to the Scherrer equation.
15. The electrochemically active material of any one of clauses 1-14, wherein the inactive phase includes one or more grains, and wherein the x-ray diffraction pattern of the alloy comprises no detectible Cu-Kα diffraction peaks associated with elemental silicon whose FWHM correspond to a grain size greater than about 20 nm, or greater than about 17 nm, according to the Scherrer equation.
16. The electrochemically active material of any one of clauses 1-15, wherein the alloy has a value of r₁₀ that is less than or equal to about 0.40, or less than or equal to about 0.35.
17. The electrochemically active material of any one of clauses 1-15, wherein the alloy has a reversible capacity greater than about 900 mAh/g.
18. The electrochemically active material of any one of clauses 1-17, wherein the alloy has a density of less than about 3.6 g/ml.
19. The electrochemically active material of any one of clauses 1-18, wherein the first cycle efficiency is greater than about 75%, or greater than about 77%.
20. An electrode composition comprising the electrochemically active material of any one of clauses 1-19 and a binder.
21. The electrode composition of clause 20, wherein the binder comprises lithium polyacrylate.
22. The electrode composition of any one of clauses 20-21, further comprising graphite.
23. A negative electrode comprising the electrode composition of any one of clauses 20-22 and a current collector.
24. An electrochemical cell comprising: the negative electrode of clause 23; a positive electrode comprising lithium; and an electrolyte comprising lithium.
25. An electronic device comprising the electrochemical cell of clause 24.
26. A method of making an electrochemical cell comprising: providing a positive electrode comprising lithium; providing a negative electrode according to clause 23; providing an electrolyte comprising lithium; and incorporating the positive electrode, negative electrode and the electrolyte into an electrochemical cell.
27. A method of making an alloy composition represented by the formula: SiₐAl_{b}Ti_{c}N_{d}OₑX_{f} comprising ball milling a powder comprising at least silicon and aluminum in an atmosphere comprising nitrogen, a mixture of nitrogen and oxygen, or air; wherein X comprises one or more of carbon, a transition metal, and tin; wherein a+b+c+d+e+f=100; wherein a>25; wherein b>0; wherein c≥0; wherein d>0; wherein d>b; wherein e≥0; wherein f≥0; and wherein a+b+c>d; and wherein the alloy includes an inactive phase comprising aluminum.
28. The method according to clause 26, wherein the ball milling comprises planetary ball milling.
29. The method according to clause 27 or 28, wherein a is greater than about 25 and less than about 85, b is greater than 0 and less or equal to about 50, c is equal to or greater than 0 and equal to or less than about 20, d is greater than 0 and equal to or less than about 50, e is equal to or greater than 0 and equal to or less than about 50, and f is equal to or greater than 0 and equal to or less than about 30.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

Unless otherwise noted, all parts, percentages, ratios, etc. in the examples and the rest of the specification are by weight, and all reagents used in the examples were obtained, or are available, from general chemical suppliers such as, for example, Sigma-Aldrich, Saint Louis, MO, US or Alfa Aesar, Haverhill, MA, US.

### Sample Preparation and Test Methods

X-ray diffraction (XRD) patterns were collected using a Siemens D5000 diffractometer equipped with a Cu Kα X-ray source.

Grain sizes of individual phases were determined by application of the Scherrer equation to the FWHM of the most intense peak of that phase in the XRD pattern.

True sample densities were measured using an ACCUPYC 111345 gas displacement helium pycnometer (Micromeritics, Norcross, Ga., US).

Electrode slurries were made by mixing alloy powders, carbon black (Super P, Imerys Graphite & Carbon) and a 10% by weight aqueous solution of lithium polyacrylate (LiPAA). The LiPAA had been made by neutralizing a polyacrylic acid solution (Sigma-Aldrich, average molecular weight ˜250,000 g/mol, 35 wt % in H₂O) with LiOH·H₂O (Sigma Aldrich, 98% in distilled water) with a solids weight ratio of 88/2/10 in distilled water. The mixing was conducted in a planetary ball mill (Tencan XQM-0.4L) with 3 WC balls at 100 rpm for a period of 1 hr. The slurries were coated on copper foil using a 0.002-inch (0.05 mm) gap coating bar and vacuum dried at 80° C. overnight.

Electrodes were assembled in 2325-type coin cells with a lithium foil (99.9%, Sigma Aldrich) counter/reference electrode. Two layers of CELGARD 2300 separator (Celgard, Charlotte, N.C., US) were used in each coin cell. 1M LiPF₆ in a solution of ethylene carbonate, ethyl methyl carbonate and monofluoroethylene carbonate (volume ratio 27:63:10, all from Soulbrain, Northville, Michigan, US) was used as the electrolyte. Cell assembly was carried out in a dry-air filled glove box.

Cells were cycled galvanostatically at 40.0±0.1° C. in a CT1601 temperature box between 0.005 V and 1.5 V using a BTS4000-5V50 mA (Neware, Mongkok, HK). Cells were lithiated (discharged) at C/10 to 0.005V then lithiated at C/40 to 0.005V, then delithiated (charged) at C/10 to 1.5V. The first cycle efficiency (FCE) was defined as: first delithiation alloy capacity/first lithiation alloy capacity×100%.

Si alloy powders were prepared by various milling methods as are known to those skilled in the art with precursors chosen to achieve the desired atomic composition. Synthesis by planetary ball milling was performed as taught in Zhang, F. L., et al. “Parameters Optimization in the Planetary Ball Milling of Nanostructured Tungsten Carbide/Cobalt Powder,” https://doi.org/10.1016/j.ijrmhm.2007.08.005, using a 100 mL planetary mill jars, 25 g of 5.5 mm diameter steel balls and 50 g of 15 mm diameter steel balls and run at 300 RPM for 16 hours. Synthesis by roller milling was performed as taught in U.S. Pat. No. 8,287,772 B2 (the detailed description of which is incorporated herein by reference) using a 17 L steel vessel filled with 39 kg of steel balls (12.7 mm diameter). The vessel was then purged with argon, placed on a roller mill and allowed to turn at 90% critical speed for 144 hours.

### Example 1

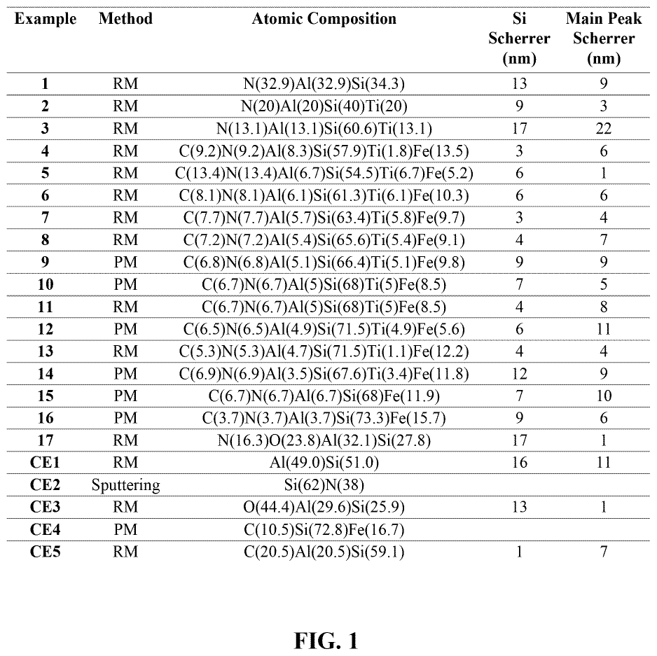

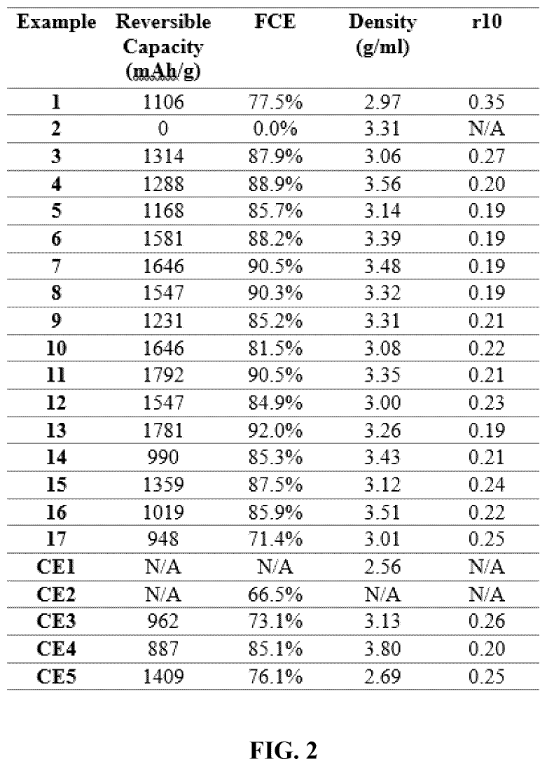

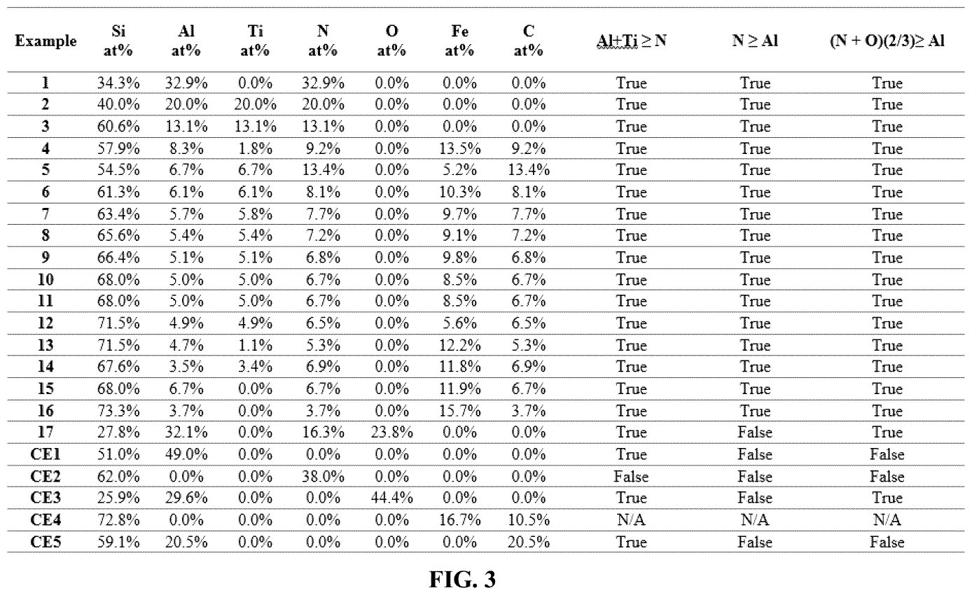

Seventeen example electrochemically active compositions and five comparative examples (CE) were prepared according to FIG. 1. FIG. 1 lists the synthesis methods (RM=roller mill, PM=planetary mill), atomic compositions, Scherrer grain size of the Silicon phase, and Scherrer grain size of the largest peak taken from XRD data. FIG. 2 lists the reversible capacity (mAh/g), first cycle efficiency (FCE), and pycnometer density (g/ml). FIG. 3 lists the atomic percentages and the application of stoichiometric rules for the design of aluminum containing nanostructured silicon alloys.

The stability of each alloy structure during electrochemical cycling was evaluated and reported in FIG. 2. Without being bound by a particular theory, it is generally believed that structural instability results in the formation of Li₁₅Si₄ during cycling and that this results in capacity fade. In electrochemical cycling measurements in half-cells, Li₁₅Si₄ formation causes a peak to occur in the differential capacity at about 0.4 V during delithiation. The total delithiation capacity of the alloy between 0.38 V to 0.48 V divided by the total delithiation capacity as the cell is cycled between 5 mV and 0.9 V was used here as a measure of the fraction of Li₁₅Si₄ formed during cycling compared to the total amount of active Si. This fraction is referred to herein as the symbol ‘r’. The value of r (termed “r₁₀”) that is reached after ten cycles during cycling was used as a measure of the alloy structural stability during cycling. Smaller r₁₀ values are indicative of improved alloy structural instability and improved cycling performance. Here r₁₀ was the value of r measured at the end of 10 charge/discharge cycles performed at 40° C. with a C/10 cycling rate for the first cycle and a nominal C/4 rate for the following cycle with a C/20 discharge (lithiation) step at the lower cutoff voltage.

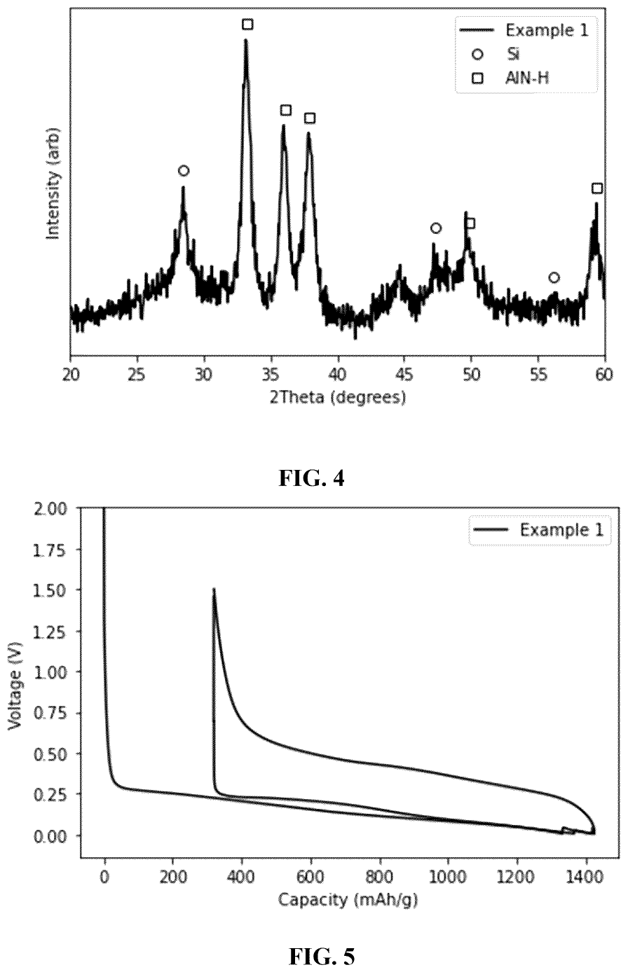

X-ray diffraction patterns for the alloys are provided in FIGS. 4-11. Peaks in the diffraction pattern are identified by the open symbols. Many examples contain a structure which is too amorphous to properly identify all the phases.

Example 1 was synthesized by planetary mill using silicon powder and hexagonal aluminum nitride powder as raw materials. FIG. 4 shows the XRD spectra of Example 1. The Si and AlN phases are identifiable by XRD and are identified as primarily Si and hexagonal AlN.

FIG. 5 shows the electrochemical performance of Example 1. As listed in the table in FIG. 1, the material has a good capacity, high first cycle efficiency, low density, and acceptable r₁₀. The results show that AlN is an excellent inactive matrix for nanostructured Si alloys and, in agreement with theory, though not bound by theory, the aluminum atom remains substantially bound to the nitrogen atom during lithiation and delithiation. Furthermore, the material is stable in a water-based slurry and compatible with standard slurry processes.

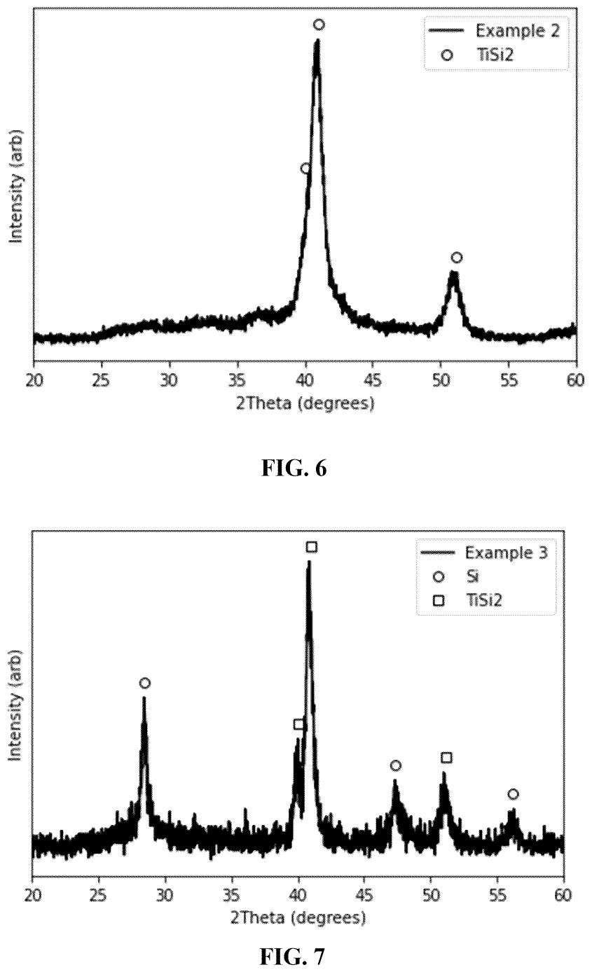

Roller milling was used to synthesize Example 2 using Si, Al and Ti powders and nitrogen gas. FIG. 6 shows the XRD spectra of Example 2, wherein the XRD shows the presence of the TiSi₂ (C49) phase (where C49 is the Strukturbericht symbol of the TiSi₂ phase formed) as well as a broad background between 30° and 40° corresponding to AlN. The presence of AlN was confirmed by the absence of activity in the electrochemical testing. Elemental aluminum is known to be an active element but the electrochemical data shows there is no lithiation capacity to this material. The aluminum is therefore completely rendered inactive when found in the AlN as predicted. Example 2 also shows that, surprisingly, when Al and Ti are both present, preferential reaction occurs between Al and N and the formation of TiN is suppressed. Example 2 shows the ability of Al to react with N and form an inactive phase. Example 2 shows that TiSi₂ is also an effective inactive phase. In Example 2 the Si has completely reacted with Ti and no elemental Si is available to form an active Si phase for lithiation and delithiation.

Roller milling was used to synthesize Example 3 using Si, Al, and Ti powders in a nitrogen atmosphere. FIG. 7 shows the XRD spectra of Example 3 wherein the Si and TiSi₂ phases are found. The aluminum nitride phase is fully amorphous.

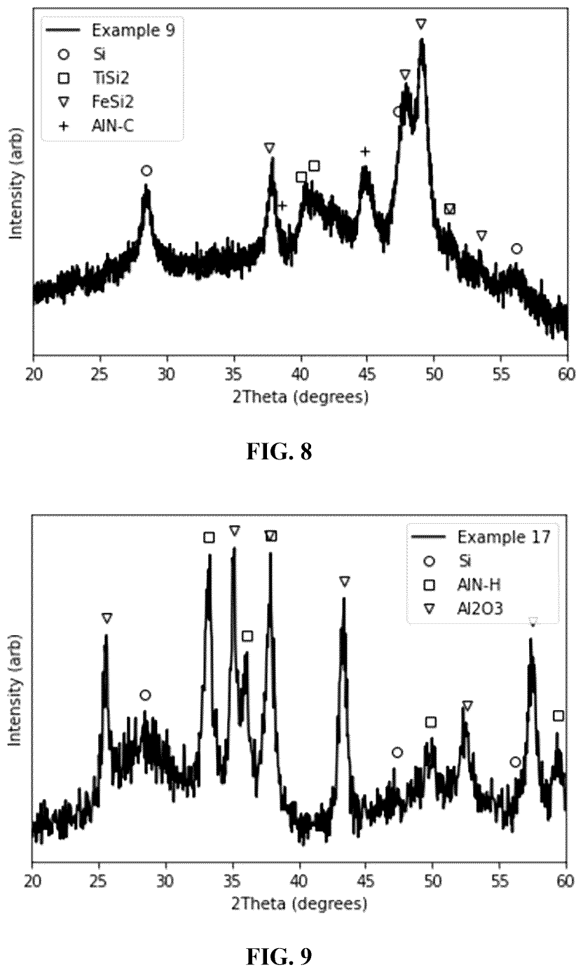

Examples 4 through 16 were synthesized by roller milling or planetary milling as listed in FIG. 1 using silicon, iron, iron ferrocyanide, optionally graphite, and optionally titanium powders. XRD spectra was taken of all samples. FIG. 8 shows the XRD spectra of Example 9 showing presence of iron silicide, titanium silicide, cubic aluminum nitride, and silicon phases. These examples which have high first cycle efficiency, low density and low r₁₀, show that the aluminum nitride is an effective inactive phase in co-existence with transition metal inactive phases.

Roller milling was used to synthesize Example 17 using silicon, alumina, and hexagonal aluminum nitride powders. FIG. 9 shows the XRD spectra of Example 17 and demonstrates the presence of silicon, hexagonal aluminum nitride, and alumina phases.

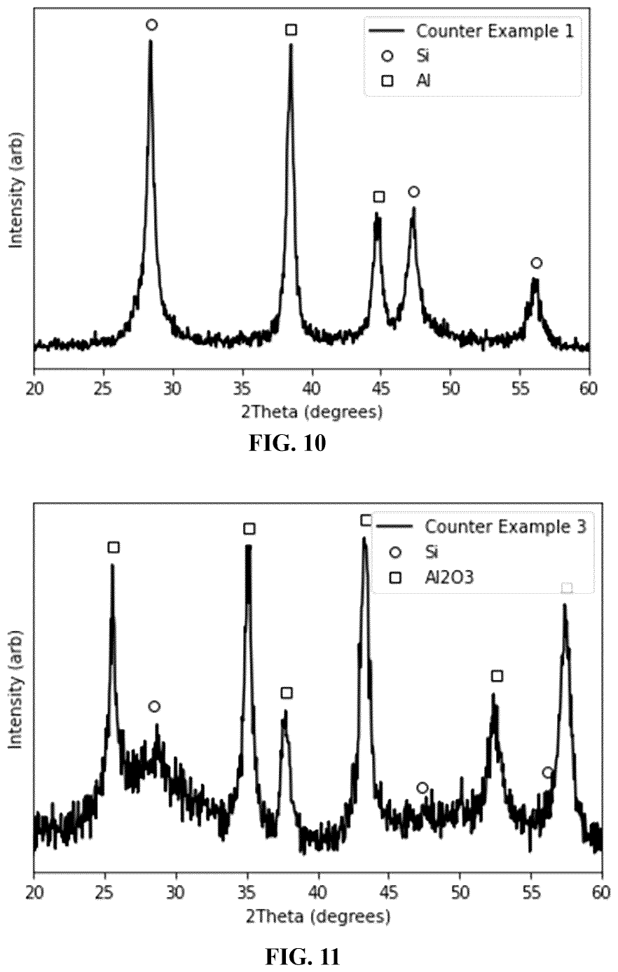

Roller milling was used to synthesize CE1, a SiAl alloy using silicon and aluminum powders. FIG. 10 shows the XRD spectra demonstrating that Si and Al phases are present in the resulting alloy. When this material was used to make a slurry to coat a negative electrode, the slurry solidified due to the activity of the elemental aluminum. This shows the material as being unacceptable as a nanostructured silicon alloy due to the absence of nitrogen bound to the aluminum.

CE2 is taken from the literature where Ulvestad et al. synthesized silicon-nitrogen materials. The Si₆₂N₃₈ shows the material as having a low first cycle efficiency (66.5%) due to the reactivity of nitrogen with lithium in the absence of aluminum.

Roller milling was used to synthesize CE3, a SiAlO alloy using silicon and alumina (Al₂O₃) powders. FIG. 11 shows the XRD spectra for CE3, demonstrating that the Si phase and the Al₂O₃ phase are present in the resulting alloy. Electrochemical testing of this sample yields a low first cycle efficiency of 73% as shown in FIG. 2. This low first cycle efficiency is due to the reactivity of the alumina inactive phase with the lithium during lithiation.

Planetary milling was used to synthesize CE4, a SiFeC alloy using silicon, iron, and graphite powders. This example shows that the use of solely transition metals results in a high density (3.80 g/cc), which is not preferred.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. An electrochemically active material comprising an alloy represented by the formula: 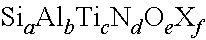
wherein X comprises one or more of carbon, a transition metal, and tin;
wherein a+b+c+d+e+f=100;
wherein a>25;
wherein b>0;
wherein c≥0;
wherein d>0;
wherein d>b;
wherein e≥0;
wherein f≥0;
wherein a+b+c>d; and
wherein the alloy comprises an inactive phase comprising aluminum.

2. The electrochemically active material of claim 1, wherein the inactive phase comprises aluminum nitride.

3. The electrochemically active material of any one of claims 1-2, wherein d+(⅔e)>b.

4. The electrochemically active material of any one of claims 1-3, wherein b+c>d.

5. The electrochemically active material of any one of claims 1-4, wherein a is greater than about 25 and less than about 85, b is greater than 0 and less or equal to about 50, c is equal to or greater than 0 and equal to or less than about 20, d is greater than 0 and equal to or less than about 50, e is equal to or greater than 0 and equal to or less than about 50, and f is equal to or greater than 0 and equal to or less than about 30.

6. The electrochemically active material of any one of claims 1-5, wherein the inactive phase comprises a Scherrer grain size less than about 25 nm, or less than about 22 nm.

7. The electrochemically active material of any one of claims 1-6, wherein the alloy comprises a transition metal silicide phase, wherein the phase has a Scherrer grain size between about 1 nm and about 25 nm, or between about 1 nm and about 22 nm.

8. The electrochemically active material of any one of claims 1-7, wherein X comprises C, V, Cr, Mn, Fe, Co, Ni or Cu.

9. The electrochemically active material of any one of claims 1-8, wherein X comprises carbon.

10. The electrochemically active material of any one of claims 1-9, wherein X comprises C and Fe.

11. The electrochemically active material of any one of claims 1-10, wherein the alloy comprises a transition metal silicide phase.

12. The electrochemically active material of any one of claims 1-11, wherein the alloy comprises a phase having x-ray diffraction peaks characteristic of a titanium silicide phase and is free of peaks characteristic of a titanium nitride phase.

13. The electrochemically active material of any one of claims 1-12, wherein the alloy comprises an elemental silicon phase having a Scherrer grain size that is less than or equal to about 20 nm, or less than or equal to about 17 nm.

14. The electrochemically active material of any one of claims 1-13, wherein the inactive phase comprises one or more grains, and wherein the x-ray diffraction pattern of the alloy comprises no detectible Cu-Kα diffraction peaks whose FWHM correspond to a grain size greater than about 25 nm, or greater than about 22 nm, according to the Scherrer equation.

15. The electrochemically active material of any one of claims 1-14, wherein the inactive phase includes one or more grains, and wherein the x-ray diffraction pattern of the alloy comprises no detectible Cu-Kα diffraction peaks associated with elemental silicon whose FWHM correspond to a grain size greater than about 20 nm, or greater than about 17 nm, according to the Scherrer equation.

16. The electrochemically active material of any one of claims 1-15, wherein the alloy has a value of r₁₀ that is less than or equal to about 0.40, or less than or equal to about 0.35.

17. The electrochemically active material of any one of claims 1-15, wherein the alloy has a reversible capacity greater than about 900 mAh/g.

18. The electrochemically active material of any one of claims 1-17, wherein the alloy has a density of less than about 3.6 g/ml.

19. The electrochemically active material of any one of claims 1-18, wherein the first cycle efficiency is greater than about 75%, or greater than about 77%.

20. An electrode composition comprising the electrochemically active material of any one of claims 1-19 and a binder.

21. The electrode composition of claim 20, wherein the binder comprises lithium polyacrylate.

22. The electrode composition of any one of claims 20-21, further comprising graphite.

23. A negative electrode comprising the electrode composition of any one of claims 20-22 and a current collector.

24. An electrochemical cell comprising:
the negative electrode of claim 23;
a positive electrode comprising lithium; and
an electrolyte comprising lithium.

25. An electronic device comprising the electrochemical cell of claim 24.

26. A method of making an electrochemical cell comprising:
providing a positive electrode comprising lithium;
providing a negative electrode according to claim 23;
providing an electrolyte comprising lithium; and
incorporating the positive electrode, negative electrode and the electrolyte into an electrochemical cell.

27. A method of making an alloy composition represented by the formula: 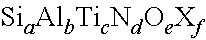
comprising ball milling a powder comprising at least silicon and aluminum in an atmosphere comprising nitrogen, a mixture of nitrogen and oxygen, or air;
wherein X comprises one or more of carbon, a transition metal, and tin;
wherein a+b+c+d+e+f=100;
wherein a>25;
wherein b>0;
wherein c≥0;
wherein d>0;
wherein d>b;
wherein e≥0;
wherein f≥0; and
wherein a+b+c>d; and
wherein the alloy includes an inactive phase comprising aluminum.

28. The method according to claim 26, wherein the ball milling comprises planetary ball milling.

29. The method according to claim 27 or 28, wherein a is greater than about 25 and less than about 85, b is greater than 0 and less or equal to about 50, c is equal to or greater than 0 and equal to or less than about 20, d is greater than 0 and equal to or less than about 50, e is equal to or greater than 0 and equal to or less than about 50, and f is equal to or greater than 0 and equal to or less than about 30.
